(19) United States
(12) Patent Application Publication
(10) Pub. No.: US 2016/0358193 A1
(43) Pub. Date: Dec. 8, 2016

(54) Technology Platform for Matching Demand-Side and Supply-Side Users

(71) Applicant: Realine Technology Inc., Chicago, IL (US)

(72) Inventors: Daniel G. Yunes, Chicago, IL (US); Lukasz Kafarski, Chicago, IL (US)

(21) Appl. No.: 15/177,136

(22) Filed: Jun. 8, 2016

Related U.S. Application Data
(60) Provisional application No. 62/172,325, filed on Jun. 8, 2015.

(51) Int. Cl. G06Q 30/02

(52) U.S. Cl. CPC G06Q 30/0202; G06Q 30/0201

(57) ABSTRACT

Disclosed herein are systems, devices, and methods for for improving the technology related to matching supply-side users with demand-side users in a marketplace. An opportunity matching platform may receive one or more business opportunities created by one or more demand-side users and then provide the one or more business opportunities to a plurality of supply-side client stations. In turn, each supply-side client station may present the one or more business opportunities to a respective supply-side users, receive the user's feedback on the one or more business opportunities, and then provide the feedback data for the supply-side user back to the opportunity matching platform. Thereafter, the opportunity matching platform may process the supply-side user feedback data and then provide various information to the demand-side users and/or supply-side users that help such users reach agreement on opportunities.

### CROSS REFERENCE TO RELATED APPLICATIONS

This application claims priority to U.S. Provisional Patent Application No. 62/172,325 entitled “Method of Dynamic Business Opportunity Matching and Selection” filed Jun. 8, 2015, which is herein incorporated by reference in its entirety.

### BACKGROUND

Technological advancements have led to increased competition in the commercial space. For example, the current widespread availability of the internet as a medium of communication has dramatically expanded the number of buyers and sellers that may participate in a given marketplace. Because of the sheer number of players in today's market, there is a need for improved technology related to matching supply-side sellers with demand-side buyers in a marketplace.

### OVERVIEW

As noted, competition in the marketplace has increased in recent years, thereby leading to market fragmentation on both the supply side (e.g., sellers of goods and/or services) and demand side (e.g., buyers of goods and/or services). As a result of this fragmentation, market transparency, which typically plays a central role in promoting the fairness and efficiency of markets, has decreased. Consequently, market participants routinely select suboptimal opportunities that drive costs up for both sides of the transaction. That is, a supply-side user may incur higher costs which reduce profit margins, while a demand-side user may pay higher prices.

Moreover, existing systems for matching supply-side users with demand-side users contribute to the aforementioned problems. For example, in existing systems that provide an online marketplace, supply is typically matched with demand based on static listings posted by either side. For instance, a supply-side user may offer a particular good and/or service for a particular price, or a demand-side user may indicate a willingness to purchase a good and/or service at a given rate. In such an environment, locating a desirable opportunity often requires a market participant to manually search a vast number of postings to narrow down their options to eventually make a selection. Furthermore, even when an opportunity is selected the decision is made in isolation and not within the context of other global opportunities.

Disclosed herein are systems, devices, and methods for improving the technology related to matching supply-side users with demand-side users in a marketplace. In accordance with the present disclosure, an opportunity matching platform may facilitate interaction, via a communication network, between demand-side client stations associated with demand-side users and supply-side client stations associated with supply-side users. Within this configuration, the opportunity matching platform may receive one or more business opportunities created by one or more demand-side users and then provide the one or more business opportunities to a plurality of supply-side client stations. In turn, each supply-side client station may present the one or more business opportunities to a respective supply-side users, receive the user's feedback on the one or more business opportunities (e.g., via a user interface action such as a swipe gesture or button press), and then provide the feedback data for the supply-side user back to the opportunity matching platform. Thereafter, the opportunity matching platform may process the supply-side user feedback data and then provide various information to the demand-side users and/or supply-side users that help such users reach agreement on opportunities, including opportunity scores for supply-side users that reflect a likelihood of a supply-side user securing a given business opportunity and/or an estimated ability of the supply-side user to make a profit on the given business opportunity.

Accordingly, in one aspect, disclosed herein is a computing system (e.g., an opportunity matching platform) that is configured to receive, via a communication network, data indicative of one or more business opportunities created by one or more demand-side users, provide, via the communication network, the one or more business opportunities to a plurality of supply-side client stations that are each associated with a respective supply-side user, and then for each of the plurality of supply-side client stations: (1) receive, from the supply-side client station via the communication network, feedback data for the respective supply-side user associated with the supply-side client station, wherein the feedback data indicates a response by the respective supply-side user to each of at least a subset of the one or more business opportunities, (2) based on the received feedback data for the respective supply-side user, (a) generate a list of selected business opportunities for the respective supply-side user, and (b) for each of a least a subset of business opportunities in the list of selected business opportunities for the respective supply-side user, determine a score that reflects one or both of (i) a likelihood of the respective supply-side user securing the business opportunity and (ii) an estimated ability of the respective supply-side user to make a profit on the business opportunity; and (3) provide, to the supply-side client station via the communication network, the list of selected business opportunities and the determined score for each of the subset of business opportunities in the list of selected business opportunities for the respective supply-side user.

The disclosed computer system may include a network interface configured to facilitate communication, via a communication network, with a plurality of demand-side client stations that are each associated with a respective demand-side user and a plurality of supply-side client stations that are each associated with a respective supply-side user, at least one processor, a non-transitory computer-readable medium, and program instructions stored on the non-transitory computer readable medium that are executable by the at least one processor to cause the computing system to perform one or more of the functions disclosed herein.

In another aspect, disclosed herein is a client station that is associated with a given supply-side user and configured to (1) receive, from an opportunity matching platform via a communication network, one or more business opportunities created by one or more demand-side users, (2) present, via a user interface, each of the one or more business opportunities successively for evaluation by the given supply-side user, (3) while presenting each of the the one or more business opportunities, receive, via the user interface, a response by the given supply-side user to the business opportunity, (4) transmit, via the communication network, feedback data for the given supply-side user, wherein the feedback data indicates a response by the given supply-side user to each of at least a subset of the one or more business opportunities, (5) receive, from the opportunity matching platform via the communication network, (a) a list of selected business opportunities for the given supply-side user, and (b) for each of at least a subset of business opportunities in the list of selected business opportunities, a score that reflects one or both of (i) a likelihood of the given supply-side user securing the business opportunity and (ii) an estimated ability of the given supply-side user to make a profit on the business opportunity, and (6) present, via the user interface, the list of selected business opportunities for the given supply-side user and the score for each of the subset of business opportunities in the list of selected business opportunities for the given supply-side user.

The disclosed client station may include a network interface configured to facilitate communication, via a communication network, with an opportunity matching platform that facilitates interaction between demand-side users and supply-side users, a user interface, at least one processor, a non-transitory computer-readable medium, and program instructions stored on the non-transitory computer readable medium that are executable by the at least one processor to cause the client station to cause the client station to perform one or more of the functions disclosed herein.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts a structural diagram of an example platform

FIG. 3 depicts a structural diagram of an example client station

FIG. 4 is an example flow diagram that depicts one possible method for presenting, evaluating, and monitoring business opportunities.

FIG. 5a is an example interface 600a displaying a contract opportunity to a supply-side user.

FIG. 5b is an example interface 600b displaying an open-market opportunity to a supply-side user.

FIG. 5c is an example interface 600c receiving “Yes” feedback.

FIG. 5d is an example interface 600d receiving “No” feedback.

FIG. 5e is an example interface 600e receiving “MFM” feedback.

FIG. 6a is an example interface 700a displaying a “Hot List.”

FIG. 6b is an example interface 700b displaying a “MFM List.”

### DETAILED DESCRIPTION

The following disclosure makes reference to the accompanying figures and several exemplary scenarios. One of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. EXAMPLE NETWORK CONFIGURATION

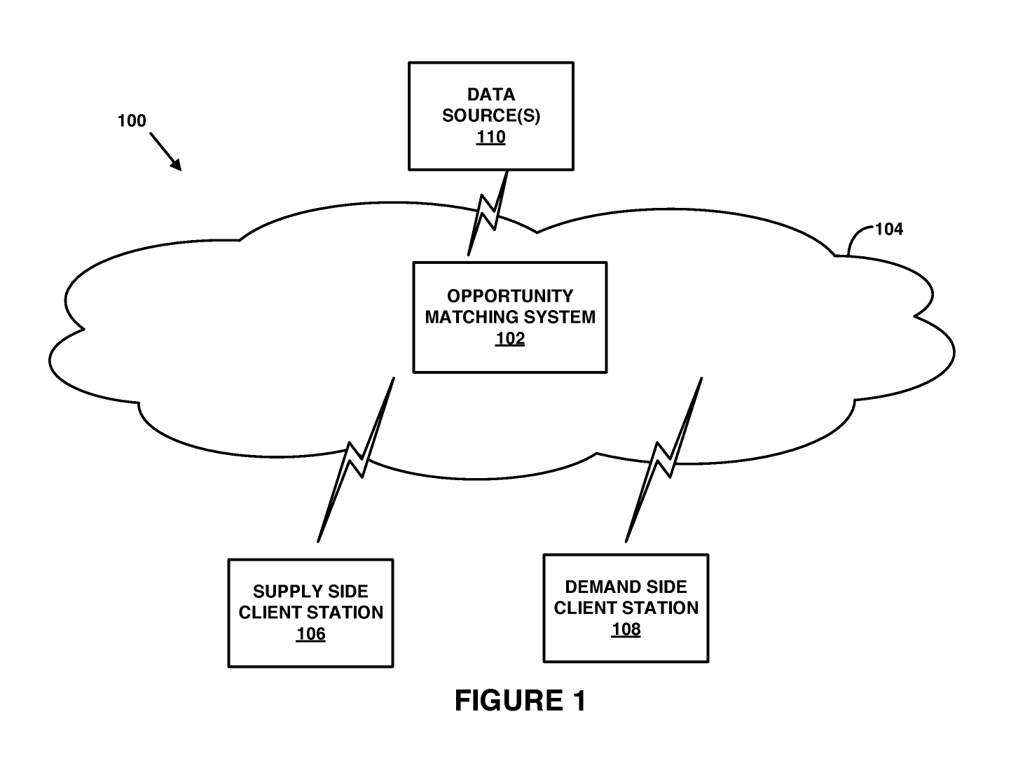

Turning now to the figures, FIG. 1 depicts an example network configuration 100 in which example embodiments may be implemented. As shown, the network configuration 100 includes at its core a remote computing system 102 that may be configured as an opportunity matching platform, which may communicate via a communication network 104 with one or more supply-side client stations, such as representative client station 106, one or more demand-side client stations, such as representative client station 108, and one or more data sources, such as representative data source 110. It should be understood that the network configuration may include various other systems as well.

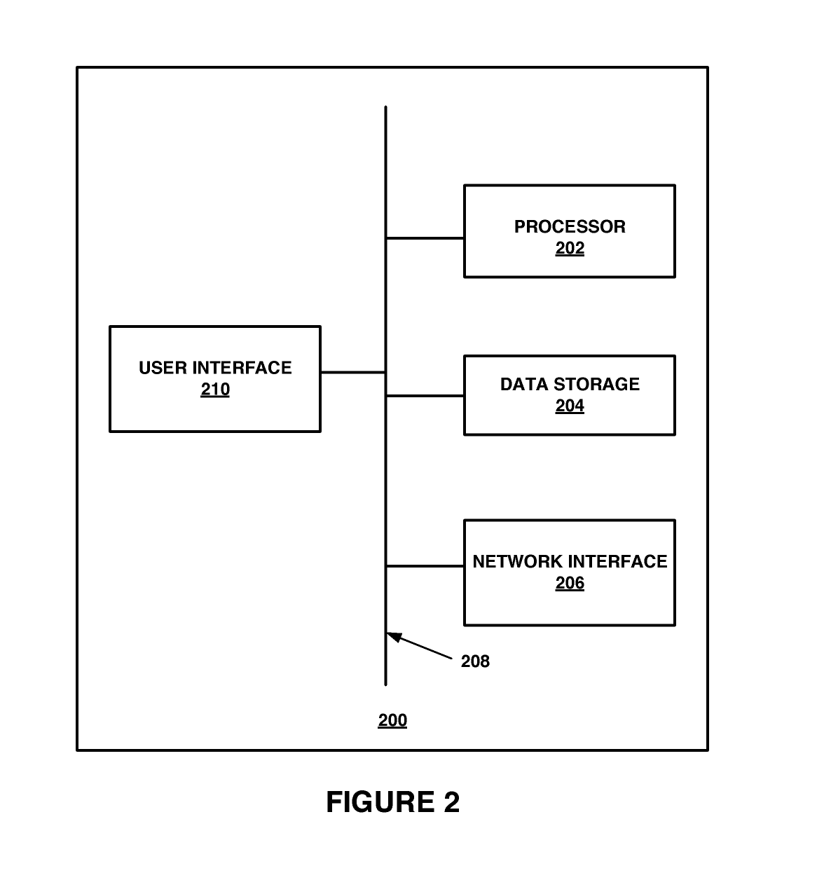

Broadly speaking, the opportunity matching platform 102 may take the form of one or more computer systems that are configured to receive, process, analyze, and/or provide access to data related to business opportunities in a marketplace (e.g., the market for goods and/or services in a fragmented marketplace like the shipping and/or logistics industry). For instance, a system may include one or more servers (or the like) having hardware components and software components that are configured to carry out one or more of the functions disclosed herein for receiving, processing, analyzing, and/or providing access to data related to business opportunities. In practice, these computing systems may be located in a single physical location or distributed amongst a plurality of locations, and may be communicatively linked via a system bus, a communication network (e.g., a private network), or some other connection mechanism. The platform may take other forms as well. A representative example of an opportunity matching platform is discussed in further detail below with reference to FIG. 2.

As shown in FIG. 1, the opportunity matching platform 102 may be configured to communicate, via the communication network 104, with the one or more supply-side client stations, one or more demand-side client stations, and/or one or more data sources. For example, the opportunity matching platform 102 may receive data related to one or more business opportunities, via the communication network 104, that is sent by one or more client stations and/or data sources. As another example, the opportunity matching platform 102 may transmit data related to one or more business opportunities, via the communication network 104, for receipt by one or more client stations. The opportunity matching platform 102 may engage in other types of communication via the communication network 104 as well.

In general, the communication network 104 may include one or more computing systems and network infrastructure configured to facilitate transferring data between opportunity matching platform 102 and the one or more supply-side client stations, one or more demand-side client stations, and/or one or more data sources. The communication network 104 may be or may include one or more Wide-Area Networks (WANs) and/or Local-Area Networks (LANs), which may be wired and/or wireless and may support secure communication. In some examples, the communication network 104 may include one or more cellular networks and/or the Internet, among other networks. The communication network 104 may operate according to one or more communication protocols, such as LTE, CDMA, GSM, LPWAN, WiFi, Bluetooth, Ethernet, HTTP/S, TCP, CoAP/DTLS and the like. Although the communication network 104 is shown as a single network, it should be understood that the communication network 104 may include multiple, distinct networks that are themselves communicatively linked. Further, in example cases, the communication network 104 may facilitate secure communications between network components (e.g., via encryption or other security measures). The communication network 104 could take other forms as well.

Further, although not shown, the communication path between the opportunity matching platform 102 and the one or more supply-side client stations, one or more demand-side client stations, and/or one or more data sources may include one or more intermediate systems (e.g., an intermediate platform, server, or the like). Many other configurations are also possible.

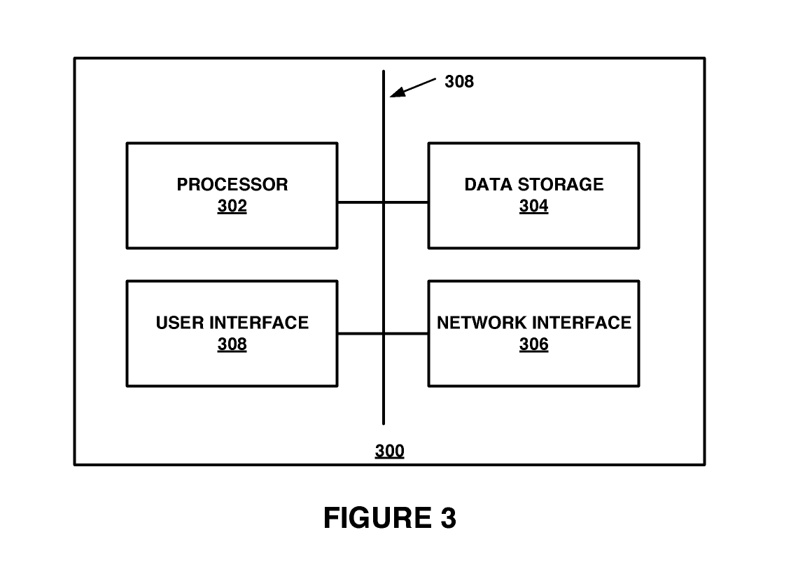

Each client station in network configuration 100 may take the form of a computing device (or system of devices) configured to access and enable a user to interact with the opportunity matching platform 102. To facilitate this, the client station may include hardware components such as a user interface, a network interface, a processor, and data storage, among other components. Additionally, the client station may be configured with software components that enable interaction with the opportunity matching platform 102, such as a native client application associated with the opportunity matching platform 102 or a web browser that is capable of accessing a web application provided by the opportunity matching platform 102, among other examples. Representative examples of client stations may include a desktop computer, a laptop, a netbook, a tablet, a smartphone, a personal digital assistant (PDA), or any other such device now known or later developed. A representative example of a client station is discussed in further detail below with reference to FIG. 3.

Generally, the representative demand-side client station 108 may be configured to enable a demand-side user (e.g., a buyer of goods and/or services) to create business opportunities for presentation to supply-side users via the opportunity matching platform 102, while the representative supply-side client station 106 may be configured to enable a supply-side user (e.g., sellers of goods and/or services) to view, evaluate, and potentially select available business opportunities via the opportunity matching platform 102. In practice, each of the client stations may be provisioned with an opportunity matching application that causes the client station to carry out these functions. The representative demand-side client station 108 and representative supply-side client station 106 may be configured to carry out various other functions in connection with the opportunity matching platform 102 as well.

In general, the data source 110 may be or include one or more computing systems configured to collect, store, and/or provide data that is related to business opportunities or is otherwise relevant to the functions performed by the opportunity matching platform 102, but does not originate from a market participant's client station. This data may take various forms, examples of which include data reflecting the cost of accepting a given opportunity (e.g., the cost of any materials needed to accept and complete the opportunity), data reflecting the location of market participants and/or business opportunities (e.g., GPS data), and data reflecting external conditions that may impact the completion of a business opportunity (traffic data, weather data, etc.), among other examples. In practice, the opportunity matching platform 102 may receive data from the data source 110 by “subscribing” to a service provided by the data source, or the opportunity matching platform 102 may receive data from the data source 110 in other manners as well.

It should be understood that the network configuration 100 is one example of a network in which embodiments described herein may be implemented. Numerous other arrangements are possible and contemplated herein. For instance, other network configurations may include additional components not pictured and/or more or less of the pictured components.

### II. EXAMPLE PLATFORM

FIG. 2 is a simplified block diagram illustrating some components that may be included in an example opportunity matching platform 200 from a structural perspective. In line with the discussion above, the opportunity matching platform 200 may generally comprise one or more computer systems (e.g., one or more servers), and these one or more computer systems may collectively include at least a processor 202, data storage 204, network interface 206, and perhaps also a user interface 210, all of which may be communicatively linked by a communication link 408 such as a system bus, network, or other connection mechanism.

The processor 202 may include one or more processor components, such as general-purpose processors (e.g., a single-core or multi-core microprocessor), special-purpose processors (e.g., an application-specific integrated circuit or digital-signal processor), controllers (e.g., microcontrollers), programmable-logic devices (e.g., a field programmable gate array), and/or any other processor components now known or later developed.

In turn, data storage 204 may comprise one or more non-transitory computer-readable storage mediums, examples of which may include volatile storage mediums such as random access memory, registers, cache, etc. and non-volatile storage mediums such as read-only memory, a hard-disk drive, a solid-state drive, flash memory, an optical-storage device, etc.

As shown in FIG. 2, the data storage 204 may be provisioned with software components that are executable by the processor 202 and enable the platform 200 to carry out the platform-side functions disclosed herein. For instance, as described in more detail below, the platform 200 may be provisioned with software components that enable the platform 200 to interact with demand-side and/or supply-side client stations that are running a suitable application (e.g., an opportunity matching application, which may take the form of a native client application or a web application as examples). These software components may generally take the form of program instructions that are executable by the processor 202, and may be arranged together into applications, virtual machines, or the like.

In addition, the data storage 204 may also be contain one or more databases that are arranged to store data related to the functions carried out by the platform. As one possible example, the data storage 204 may be provisioned with a database that is arranged to store user profiles for demand-side and/or supply-side users that are subscribed to use the opportunity matching platform 200. These user profiles may include various information, examples of which include identifying information for the user (e.g., name, location, contact information, available equipment, insurance level, userID, password etc.), information regarding the user's created opportunities (for demand-side users) and/or selected opportunities (for supply-side users), and information regarding the user's settings and preferences. As another possible example, the data storage 204 may be provisioned with a database that is arranged to store data related to business opportunities that have been created by demand-side client stations and/or provided to supply-side client stations. The data storage 204 may be provisioned with other databases and/or be arranged to store other data as well. Further, it should be understood that the opportunity matching platform 200 could be configured to access one or more databases that are hosted on a computing system external to the opportunity matching platform 200. Other configurations are possible as well.

The network interface 206 may be configured to facilitate wireless and/or wired communication between the opportunity matching platform 200 and various network components via the communication network 104, such supply-side client station 106, demand-side client station 108, and data source 110. As such, network interface 206 may take any suitable form for carrying out these functions, examples of which may include an Ethernet interface, a serial bus interface (e.g., Firewire, USB 2.0, etc.), a chipset and antenna adapted to facilitate wireless communication, and/or any other interface that provides for wired and/or wireless communication. Network interface 206 may also include multiple network interfaces and/or support various different types of network connections. Other configurations are possible as well.

The example opportunity matching platform 200 may also support a user interface 210 that is configured to facilitate user interaction with the platform 200 and may also be configured to facilitate causing the platform 200 to perform an operation in response to user interaction. This user interface 210 may include or provide connectivity to various input components, examples of which include touch-sensitive interfaces, mechanical interfaces (e.g., levers, buttons, wheels, dials, keyboards, etc.), and other input interfaces (e.g., microphones). Additionally, the user interface 210 may include or provide connectivity to various output components, examples of which may include display screens, speakers, headphone jacks, and the like. Other configurations are possible as well, including the possibility that the user interface 210 is embodied within a client station that is communicatively coupled to the example platform.

One of ordinary skill in the art will appreciate that the example platform shown in FIG. 2 is but one example of a simplified representation of the components that may be included in a platform and that numerous others are also possible. For instance, other platforms may include additional components not pictured and/or more or less of the pictured components. Moreover, a given platform may include multiple, individual platforms that are operated in concert to perform operations of the given platform. Other examples are also possible.

### III. EXAMPLE CLIENT STATION

Turning to FIG. 3, a simplified block diagram of an example client station 300 is depicted. Either or both of supply-side client station 106 or demand-side client station 108 from FIG. 1 may be configured like client station 300. As shown, the client station 300 may include a processor 302, data storage 304, a network interface 306, and a user interface 308, all of which may communicatively linked by a communication link 308 such as a system bus, or other connection mechanism. In example implementations, client station 300 may take the form of a desktop computer, a laptop, a netbook, a tablet, a smartphone, a PDA, or any other such device now known or later developed.

The processor 302 may include one or more processor components, such as general-purpose processors (e.g., a single-core or multi-core microprocessor), special-purpose processors (e.g., an application-specific integrated circuit or digital-signal processor), controllers (e.g., microcontrollers), programmable-logic devices (e.g., a field programmable gate array), and/or any other processor components now known or later developed.

In turn, data storage 304 may comprise one or more non-transitory computer-readable storage mediums, examples of which may include volatile storage mediums such as random access memory, registers, cache, etc. and non-volatile storage mediums such as read-only memory, a hard-disk drive, a solid-state drive, flash memory, an optical-storage device, etc.

Additionally, data storage 304 may be provisioned with one or more software components that are executable by the processor 302 and enable the client station 300 to carry out the demand-side and/or supply-side functions disclosed herein. For instance, as described in more detail below, the client station 300 may be provisioned with one or more software components, such as an opportunity matching application that takes the form of a native client application or a web application, that facilitates interaction of a demand-side and/or supply-side user with the opportunity matching platform 102. The client station 300 may be provisioned with various other software components as well.

In addition, the data storage 304 may also contain data related to the functions carried out by the client station. For instance, the data storage 304 may contain data related to one or more business opportunities, which may be entered by a demand-side user, received from the opportunity matching platform 102, or otherwise generated by the client station 300. The data storage 304 may contain various other data as well.

The network interface 306 may be configured to facilitate wireless and/or wired communication between client station 300 and various network components via the communication network 104, such as the opportunity matching platform 102, data source 110, or one or more other client stations. As such, network interface 306 may take any suitable form for carrying out these functions, examples of which may include an Ethernet interface, a serial bus interface (e.g., Firewire, USB 2.0, etc.), a chipset and antenna adapted to facilitate wireless communication, an infrared interface, a radio based interface, and/or any other interface that provides for wired and/or wireless communication. Network interface 306 may also include multiple network interfaces and/or support various types of network connections.

The user interface 308 may be configured to facilitate user interaction with the client station 300 and may also be configured to facilitate causing client station 300 to perform a function in response to user interaction. In examples, user interface 308 may include or provide connectivity to various input components, examples of which may include a touch-sensitive interface, a mechanical interface (e.g., levers, buttons, wheels, dials, keyboards, etc), and other input interfaces (e.g., microphones, proximity detectors, etc.). Additionally, the user interface 310 may include or provide connectivity to various output components, examples of which may include a display screen, speakers, a headphone jack, and the like. Other configurations are possible as well.

One of ordinary skill in the art will appreciate that the example platform shown in FIG. 3 is but one example of a simplified representation of the components that may be included in a client station and that numerous others are also possible. For instance, other platforms may include additional components not pictured and/or more or less of the pictured components. Other examples are also possible.

### IV. EXAMPLE OPERATIONS

The operations of the example network configuration 100 depicted in FIG. 1 will now be discussed in further detail below. To help describe some of these operations, flow diagrams may be referenced to describe combinations of operations that may be performed. In some cases, each block may represent a module or portion of program code that includes instructions that are executable by a processor to implement specific logical functions or steps in a process. The program code may be stored on any type of computer-readable medium, such as non-transitory computer-readable media. In other cases, each block may represent circuitry that is wired to perform specific logical functions or steps in a process. Moreover, the blocks shown in the flow diagrams may be rearranged into different orders, combined into fewer blocks, separated into additional blocks, and/or removed based upon the particular embodiment.

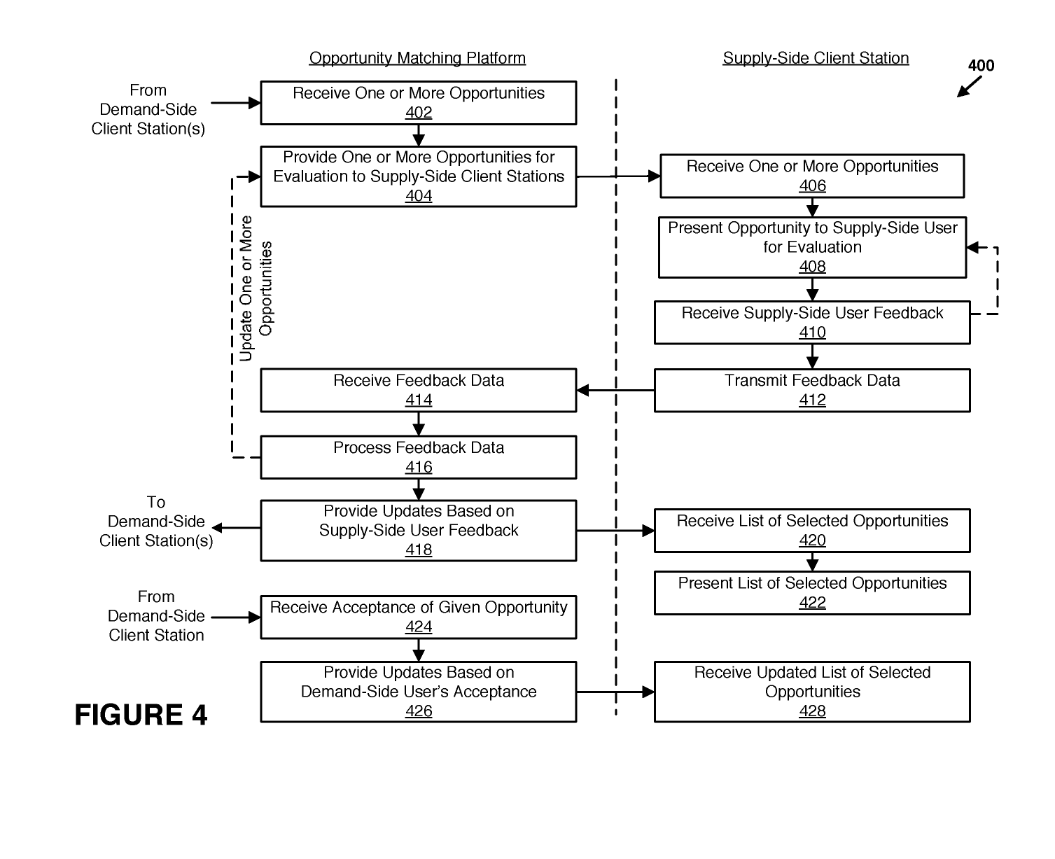

FIG. 4 is an example flow diagram 400 depicting functions that can be carried out in accordance with the present disclosure. For the purposes of illustration only, these functions are described with reference to the the network configuration depicted in FIG. 1, but it should be understood that these function may be carried out by other systems and/or device. One of ordinary skill in the art will also appreciate that the flow chart 400 is provided for sake of clarity and explanation and that numerous other combinations of operations may be utilized.

As shown in FIG. 4, at block 402, the opportunity matching platform 102 may be configured to receive, via communication network 104, a plurality of business opportunities created by demand-side client stations in the network configuration 100, such as the representative demand-side client station 108. In example embodiments, the representative demand-side client station 108 may create a given opportunity based on the input of a demand-side user. To facilitate this function, the representative demand-side client station 108 may be running a software application, such as an opportunity matching application that takes the form of a native client application or a web application, which may guide a user through the process of creating a new business opportunity and then cause the representative demand-side client station 108 to transmit the created business opportunity to the opportunity matching platform 102. In practice, a demand-side user may be a buyer seeking to purchase a good and/or service from a supply-side user. As a few representative examples, a demand-side user may be looking to purchase a good such as a vehicle, a musical instrument, an article of clothing, etc., or a service such as a shipping, logistics, transportation, etc. Many other examples are possible as well.

In general, each business opportunity received by the opportunity matching platform 102 at block 402 includes an indication of a particular good and/or service that a particular demand-side user wishes to be provided by a supply-side user, along with additional information that defines the opportunity such as a narrative description of the opportunity, a location associated with the good and/or service being requested, a date and/or time at which the good and/or service is being requested, etc. These received business opportunities may take a number of forms.

In one instance, a received business opportunity may take the form of a “contract opportunity,” which is a business opportunity that includes a predefined price that is set by the demand-side user (e.g., via an application running on the demand-side client station 108). Such a contract opportunity may be desirable in those cases in which a demand-side user is generally aware of the market price demanded by the supply side for a particular good and/or service. As one representative example, a demand-side user may know from prior experience that the typical market rate for a given service is $100, and may then create a new opportunity for that service with a set a price of $95.

In another instance, a received business opportunity may take the form of an “open-market opportunity,” which is a business opportunity that is not associated with a set price but is instead offered at one or more pricing options that are defined by the opportunity matching platform 102. A given demand-side user may user may wish to create an open-market opportunity when he or she knows which good and/or service they require but are uncertain about the price they are either willing to pay and/or the typical price for the opportunity demanded by the supply side of the market, in which case a demand-side user may create the opportunity (e.g., via an opportunity matching application running on the demand-side client station 108) without indicating the price.

Upon receiving an open-market opportunity, the opportunity matching platform 102 may then be configured to define one or more price options for the open-market opportunity. For instance, the opportunity matching platform 102 may generate an initial set of price options for a given open-market opportunity based on historical opportunity data which may be maintained by data storage 204 or retrieved by the platform from an external source such as representative data source 110. In some examples, the historical opportunity data utilized to generate the initial set of price options may take the form of data indicating previous price points accepted by demand-side users for similar opportunities, contract rates accepted by supply-side users for similar opportunities, among various other forms of historical data. Furthermore, in a situation where the historical opportunity data is not available (e.g., no available previously accepted occurences of price points for similar opportunities, etc.), the platform may be configured to dynamically generate the initial set of price options (e.g., dynamically define an initial range of prices) for an open-market opportunity. Thereafter, the platform may adjust the dynamically generated price options corresponding to the open-market opportunity based on received supply-side user feedback data, as will be discussed in further detail below.

In practice, the initial set of price options for an open-market opportunity may accompany a given open-market opportunity when provided to a first supply-side user. Generally, the price options may be represented by varying monetary amounts that a supply-side user may accept to fulfill a given open-market opportunity. Furthermore, the opportunity matching platform 102 may be configured to correlate each generated price option for a given opportunity to a probability indicating the likelihood that a supplier making a bid at that price option will be selected by the demand-side user who created the opportunity. As one illustrative example, the opportunity matching platform 102 may generate three initial price options of $1400, $1100, and $800 for an open-market opportunity involving transporting a vehicle from Chicago to Los Angeles, wherein the price options are respectively correlated to the probabilities 10%, 50%, and 90%. It may be concluded from such an example that the opportunity matching platform 102 may assume an inverse relationship between the price options and probabilities of selection. That is, demand-side users may be more likely to select suppliers that are willing to fulfill their created opportunity at a lower cost.

As described in further detail below, the opportunity matching platform 102 may also be configured to dynamically update the set of price options for an open-market opportunity based on feedback data received from supply-side client stations. In example implementations, the opportunity matching platform 102 may be configured to “push” data indicating updated price options for provided open-market opportunities as the updates occur. Additionally, the platform may configured to wait to provide data indicating updated price options based various factors. For example, based on data density and/or the velocity of feedback received the platform may be configured hold and/or batch open-market opportunity price option updates to be transmitted at a time in the future.

After receiving an opportunity from the demand-side client station 108 (and perhaps defining the price options if it is an open-market opportunity), the opportunity matching platform 102 may be configured to store the received opportunity in data storage 204.

In example embodiments, the opportunity matching platform 102 also may be configured to perform other pre-processing functions in connection with the opportunities received at block 402. For instance, the opportunity matching platform 102 may function to aggregate the received business opportunities into various groups of opportunities and cause the opportunities within each group to be stored in association with one another. The business opportunities may be stored for example in data storage 204 and/or in data storage external to the opportunity matching platform 102.

The opportunity matching platform 102 may aggregate the business opportunities based on a number of factors. For instance, the opportunity matching platform 102 may aggregate the received business opportunities based on the type of opportunity. That is, the opportunity matching platform 102 may separately group contract opportunities and open-market opportunities. Additionally or alternatively, the opportunity matching platform 102 may aggregate the received business opportunities into groups based on one or more other attributes of the opportunities, such as the type of goods/or services being requested, the location of the goods and/or service being requested, the date and/or time at which the goods and/or services are being requested, and/or information about the demand-side user (e.g., user rating), among other possibilities. In this respect, the opportunity matching platform 102 may be able to use these opportunity groupings together with information about a supply-side user (e.g., a user profile and/or other information regarding a supply-side user's preferences) to tailor the list of business opportunities that are provided to the supply-side user.

At block 404, the opportunity matching platform 102 may then provide one or more received opportunities to one or more supply-side client stations that are configured to interact with the opportunity matching platform 102, such as the supply-side client station 106. (Although the discussion below focuses on the opportunity matching platform's interaction with the representative supply-side client station 106, it should be understood that in practice, the opportunity matching platform 102 will preferably provide the one or more opportunities to any supply-side client station participating in the relevant market).

The act of providing opportunities to the supply-side client station 106 may take various forms. In one implementation, the opportunity matching platform 102 may be configured to automatically “push” the one or more opportunities to the supply-side client station 106 in response to one or more triggering events, such as the platform receiving newly-created opportunities that are to be presented to the supply-side client station 106 for instance. In another implementation, the opportunity matching platform 102 may provide the one or more opportunities to the supply-side client station 106 in response to a “pull” request received from the supply-side client station 106. The supply-side client station 106 may send such a request to the opportunity matching platform 102 in response to user input, a timer, or some other triggering event. The act of providing the one or more opportunities to the the supply-side station 106 may take other forms as well.

Further, the opportunity matching platform 102 may provide the one or more opportunities to the supply-side client station 106 either as a series of one or more individual opportunities or as a one or more batches of opportunities. For example, the opportunity matching platform 102 may be configured to “push” each opportunity to the supply-side client station 106 as the opportunity is received from a demand-side user, or the opportunity matching platform 102 may be configured to compile and send a batch of opportunities received from one or more demand-side users.

At block 406, the supply-side client station 106 may receive the one or more opportunities from the opportunity matching platform 102. Thereafter, at block 408, the supply-side client station 106 may begin to present the received one or more opportunities to a given supply-side user via the client station's user interface (e.g., user interface 308), so that the given supply-side user can evaluate each opportunity. In a preferred embodiment, this function may be carried out by an opportunity matching application that is running on the supply-side client station 106, although other embodiments are possible as well. Such an application may cause the the supply-side client station 106 to present the one or more opportunities via the user interface in various manners. According to one example, the application may cause the the supply-side client station 106 to present the one or more opportunities in succession (i.e., one at a time), thereby allowing the given supply-side user to evaluate and input the user's feedback for each given opportunity before being presented with another opportunity.

In turn, at block 410, the supply-side client station 106 may receive the given supply-side user's feedback for the opportunity currently being presented to the user via the client station's user interface. After receiving this feedback, the opportunity matching application may cause the supply-side client station 106 to loop back to block 408 and present the next available opportunity to the given supply-side user. In this way, the opportunity matching application may enable the given supply-side user to rapidly evaluate a large number of opportunities in succession.

The opportunity matching application may enable the supply-side client station 106 to present an opportunity and receive user feedback on that opportunity via the client station's user interface in a number of manners. For instance, the opportunity matching application may cause the supply-side client station 106 to present the opportunity with various response options that may be selected by a user via the client station's user interface. In one example, the opportunity matching application may cause the supply-side client station 106 to present a contract opportunity with a “Yes” option (e.g., an indication of positive interest for the specific opportunity), a “No” option (e.g., an indication of negative interest for the specific opportunity), and/or a “Maybe For More” (“MFM”) option (e.g., an indication that the given supply-side user is interested in the opportunity but under different terms). As another example, the opportunity matching application may cause the supply-side client station 106 to present an open-market opportunity with a set of different price options, each corresponding to different probability of the given supply-side user securing the opportunity (i.e., a set of price option/probability pairs).

The opportunity matching application may also enable the given supply-side user to select one of the presented options in various manners. For instance, the given supply-side user may select an option via a touch or a swipe gesture on a touchscreen of the supply-side client station 106. The given supply-side user's selection may take other forms as well.

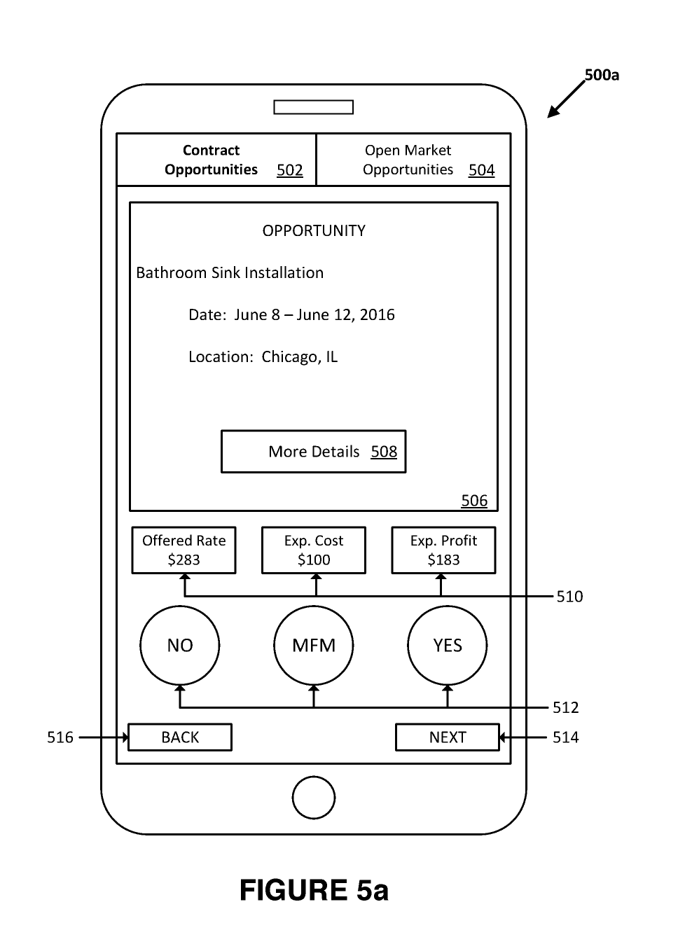

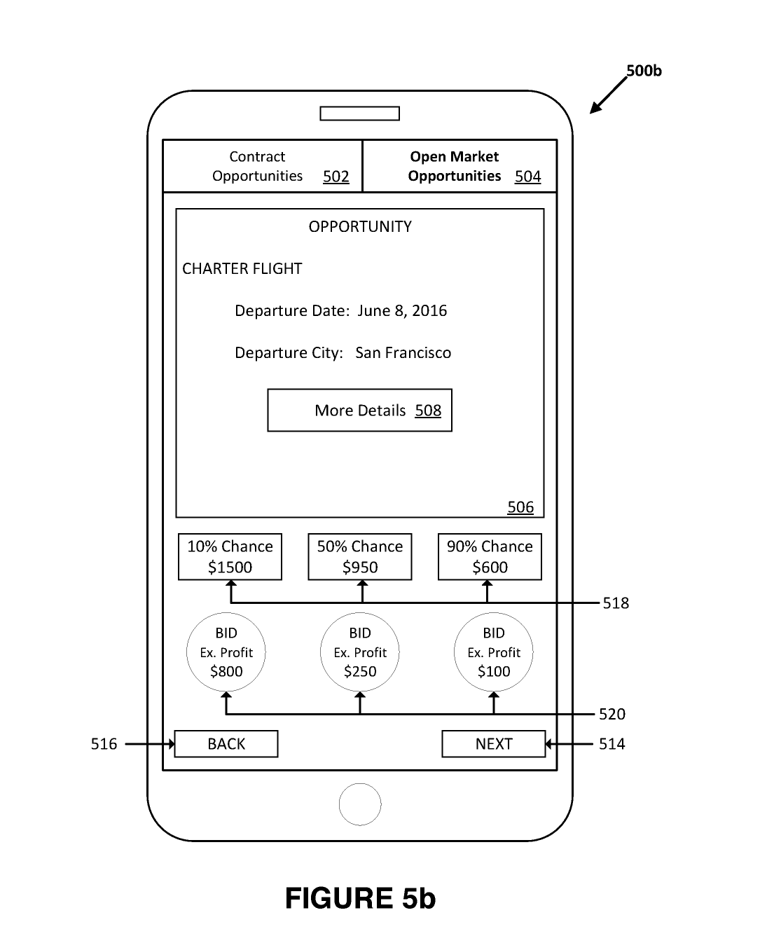

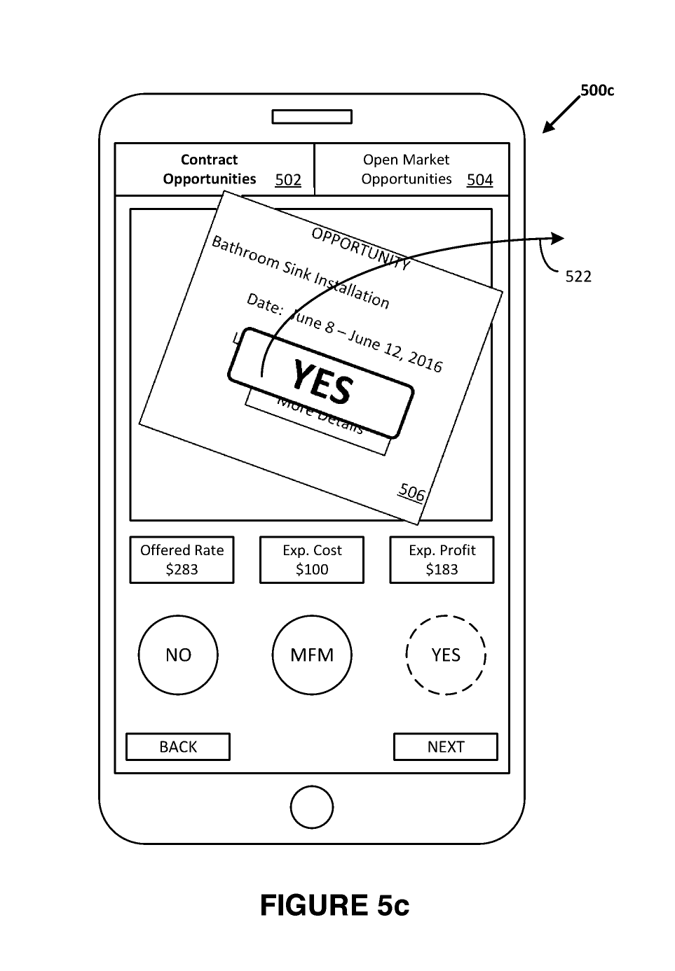

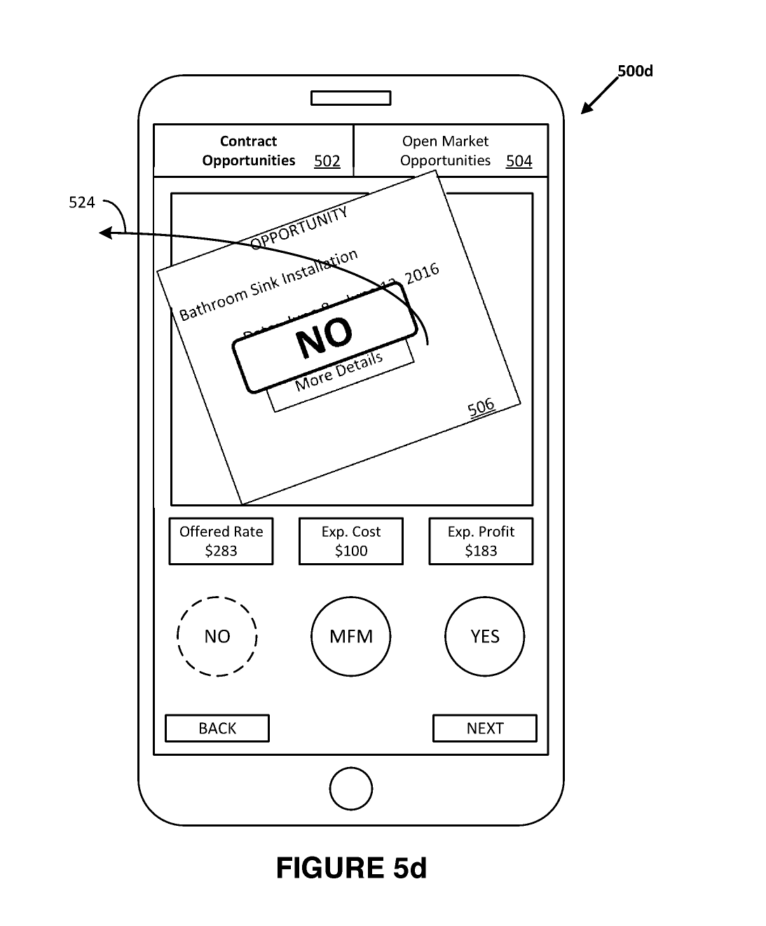

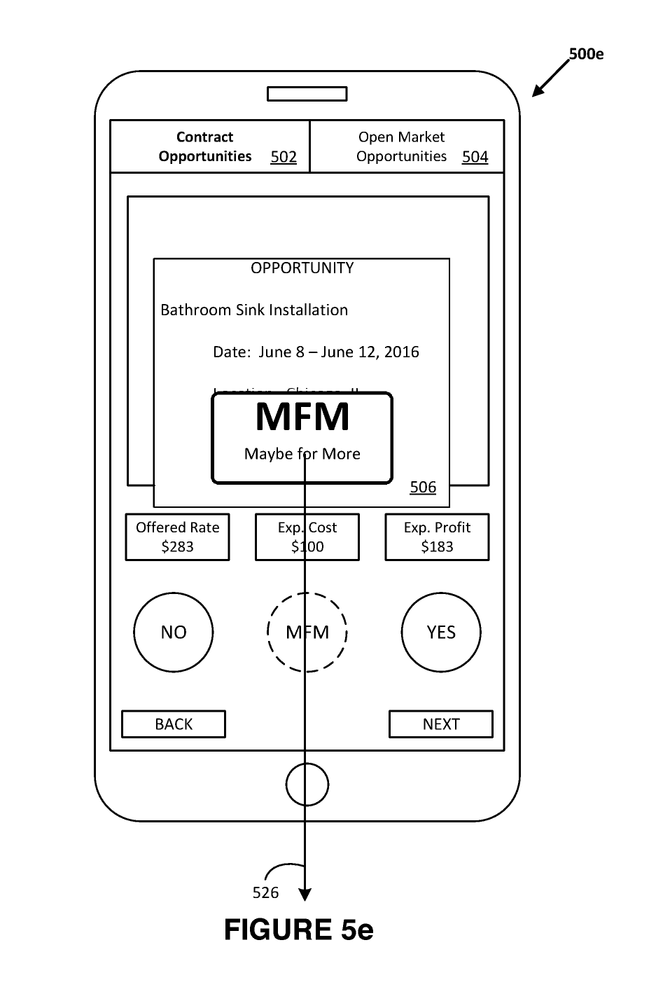

Turning to FIGS. 5a-e, some example graphical user interfaces (GUIs) are shown that may be provided by an opportunity matching application in order present opportunities and obtain user feedback for such opportunities via the client station's user interface.

FIG. 5a shows an example GUI 500a for presenting a contract opportunity to a supply-side user. In operation, a user may use the contract opportunities tab 502 and the open-market opportunities tab 504 to toggle between these different types of opportunities. As seen in FIG. 5a, contract opportunities tab 502 is indicated as selected, and correspondingly a contract opportunity for a bathroom sink instillation is presented for evaluation.

As shown, the GUI 500a for presenting a contract opportunity may include a details pane 506, which may display details provided by a demand-side user and/or retrieved from one or more data sources. In some embodiments, details pane 506 may present a subset of details corresponding to a given opportunity, in which case the more details button 508 may be operable to receive an input requesting additional details be displayed.

Additionally, GUI 500a may present a set of monetary values 510 corresponding to the contract opportunity. For example, the set of monetary values 510 may include the offered rate for the opportunity (e.g., predefined price set by the demand-side user), the cost the supply-side user can be expected to incur, and/or the profit the supply-side user can be expected to make, among other examples.

In the GUI 500a, a user may provide feedback on the presented contract opportunity in various manners. As one option, the user may touch (or otherwise select via the client station's user interface) one of the “Level of Interest” buttons 512.

As another option, the user may input a given “level of interest” using a swipe gesture on the client station's user interface. For instance, as shown in FIG. 5c, a user may perform a rightward swipe gesture 522 to select “YES.” Alternatively, as shown in FIG. 5d, a user may perform a leftward swipe gesture 524 to select “NO.” Alternatively yet, as shown in FIG. 5e, a user may perform a downward swipe gesture 526 to select “MFM.” The opportunity matching application may enable a user to input feedback on a contract opportunity in other manners as well.

Once the user inputs the “level of interest” for the presented contract opportunity, the supply-side client station may present the next contract opportunity for evaluation. In some cases, a user may not wish to evaluate a presented contract opportunity, and thereby may utilize the “Next” button 514 and the “Back” button 516 to navigate to another contract opportunity.

FIG. 5b shows an example GUI 500b for presenting an open-market opportunity to a supply-side user. As seen in FIG. 5b, open-market opportunity tab 504 is indicated as selected, and correspondingly a given open-market opportunity for a “charter flight” is presented for evaluation.

As shown, as with GUI 500a, the GUI 500b may include a details pane 506, which may display details provided by a demand-side user and/or retrieved from one or more data sources. In some embodiments, details pane 506 may present a subset of details corresponding to a given opportunity, in which case the more details button 508 may be operable to receive an input requesting additional details be displayed.

Additionally, GUI 500b may present a set of price option/probability pairs 518 for the open-market opportunity. For example, the GUI 500a shows three price option/probability pairs 518 here, although it should be understood that fewer or more price option/probability pairs may be presented as well.

In GUI 500b, a given price option/probability pair may be selected in various manners. As one option, a user may select the given price option/probability pair by touching or otherwise selecting one of “Bid” buttons 520, each of which corresponds to a different price option/probability pair. As shown, the “Bid” buttons 520 may also contain supplemental information that may be helpful to a supply-side user in making a selection. For example, “Bid” buttons 520 may contain information regarding the profit margin a supply-side user can expect for each bid price option/probability pair, among other examples.

As another option, a supply-side user may select the given price option/probability pair by using a swipe gesture on the client station's user interface. For example, a user may perform a rightward swipe gesture to select a high probability price option (e.g., 90%), a leftward swipe gesture to select a low probability price option (10%), and a downward swipe gesture to perform a 50% probability price option. Various other combinations are possible.

In any event, the selection of a given price option/probability pair for the presented open-market opportunity may cause the supply-side client station to present the next available open-market opportunity for evaluation. In some cases, a user may not wish to evaluate a presented open-market opportunity, and thereby may utilize the “Next” button 514 and the “Back” button 516 to navigate to another open-market opportunity.

Referring back to FIG. 4, at block 412, the supply-side client station 106 may transmit data indicative of the given supply-side user's feedback for the one or more opportunities back to the opportunity matching platform 102. For example, the opportunity matching application may cause the the supply-side client station 106 to send the user's feedback for each respective opportunity back to the opportunity matching platform 102 as the feedback is received from the given supply-side user, or the opportunity matching application may cause the the supply-side client station 106 to compile the user's feedback for a series of opportunities and then send that feedback as a batch back to the opportunity matching platform 102. The supply-side client station 106 may transmit data indicative of the given supply-side user's feedback for the one or more opportunities back to the opportunity matching platform 102 in other manners as well.

At some point during the process of presenting the one or more opportunities, receiving feedback, and transmitting the feedback data to the opportunity matching platform 102, the supply-side client station 106 may also be configured to request and/or receive one or more additional opportunities from the opportunity matching platform 102. For example, if the supply-side client station 106 determines that it has presented and/or received feedback for the last opportunity received from the opportunity matching platform 102, the supply-side client station 106 may be configured to request one or more additional opportunities from the opportunity matching platform 102. Other examples are possible as well. If any additional opportunities are available for the given supply-side user (e.g., new opportunities received from demand-side client stations), the opportunity matching platform 102 may then provide such opportunities to the supply-side client station 106 as in block 404, and the supply-side client station 106 may then carry out the functions at blocks 406-410 for these additional opportunities.

At block 414, the opportunity matching platform 102 may receive supply-side user feedback data for the one or more opportunities from each of the one or more supply-side client stations that are participating in a market, including the supply-side client station 106. This feedback data may take various forms. In one example, the feedback data may include an identifier of each of the one or more opportunities with a corresponding indication of the supply-side user's response to the opportunity. For a contract opportunity, the indication of the supply-side user's response may indicate a “Yes” response, a “No” response, or an “MFM” response, as examples. Further, for an open-market opportunity, the indication of the supply-side user's response may indicate a bid for a particular price option. The feedback data may take other forms as well.

In turn, at block 416, the opportunity matching platform 102 may process the supply-side user feedback data for various purposes. For instance, in one aspect, the opportunity matching platform 102 may maintain a respective list of opportunities that have been selected by each supply-side user participating in the market, in which case the opportunity matching platform 102 may process the feedback data for each respective supply-side user to generate and/or update the respective list of selected opportunities for the supply-side user. Depending on the response options presented by a supply-side user's client station, this list may take various forms. In one embodiment, a supply-side user's list of selected opportunities may comprise at least a first list of opportunities for which the user either input a “YES” response (for a contract opportunity) or selected a given price option/probability pair (for an open-market opportunity). This list may be referred to as the supply-side user's “Hot List.” Additionally, the supply-side user's list of selected opportunities may also comprise a second list of opportunities for which the user input an “MFM” response on a contract opportunity, which indicates that the given supply-side user is interested in the opportunity but under different terms. This list may be referred to as the supply-side user's “MFM List.” The supply-side user's list of selected opportunities may take other forms as well.

In practice, the opportunity matching platform 102 may also maintain a list of opportunities for which a supply-side user input an “NO” response or otherwise expressed negative interest, which the opportunity matching platform 102 may use for one or more of the other purposes described below. However, this list will preferably be kept separately from the list of selected opportunities for the supply-side user.

In another aspect, the opportunity matching platform 102 may process the supply-side user feedback data to determine a score for each of the user's selected opportunities, which may reflect the given supply-side user's chances of securing the opportunity and/or the given supply-side user's ability to make a profit on the opportunity. The opportunity matching platform 102 may make this determination in various manners. In one embodiment, the opportunity matching platform 102 may employ a predictive algorithm that determines a given supply-side user's score for a given opportunity based on factors such as the current demand in the market (e.g., the number of other available opportunities in the market), the current supply in the market (e.g., the number of other supply-side users that have expressed interest the given opportunity and/or similar opportunities), the other opportunities selected by the supply-side user, and the supply-side user's cost to service the given opportunity (e.g., a monetary value indicating how much the given supply-side user must spend to fulfill a given opportunity). It should be noted, that while the determined score for a given opportunity selected by the supply side-user may serve as an indication reflective of a likelihood and/or suitably to receive an opportunity, it is eventually the demand-side user who created the given opportunity that determines which supply-side user actually gets accepted, as will be discussed below.

As noted, the opportunity matching platform 102 determine a given supply-side user's score for a given opportunity based at least in part on the current supply and demand present in the market. In example implementations, in order to facilitate the determination of the score, the platform may be configured to further determine a current market supply and demand balance, such as for specific origin/destination pairs (e.g., shipping lanes, flight routes, etc.), among other examples. In turn, the platform's determination of the current market supply and demand balance may allow it to make certain inferences in regard to a given supply-side user's chances of securing an opportunity. For example, a low demand and a high supply for an origin/destination pair may tend to suggest a lower likelihood of a given supply-side user securing an opportunity relating to that pair, whereas a high demand and low supply may indicate an increased chance of securing an opportunity.

Moreover, the determined score for a given supply-side user for a given opportunity opportunity may be based at least in part on the supply-side user's cost to service the opportunity (e.g., a monetary value indicating how much the given supply-side user must spend to fulfill a given opportunity). For example, in the context of transportation services, the cost to service a given opportunity by a given supply-side user may be the cost the supply-side user must incur to service a particular origin/destination pair. For example, the cost to transport a load from San Francisco to St. Louis may be higher for a truck driver based out of San Francisco than another truck driver located in San Diego. That is, the San Diego based truck driver may incur additional costs (e.g., fuel, vehicle wear and tear, opportunity costs, etc.) by having to drive to San Francisco to pick up the load.) In example implementations, the opportunity matching platform 102 may facilitate the determination of a cost to service a given opportunity by a given supply side user by accessing one or more external data sources, such as a fuel price data source, weather data source, material cost data source, and/or other exemplary data sources.

Additionally, the opportunity matching platform 102 may determine a score for a given supply-side user for a given opportunity by taking into account the user's previously selected opportunities. In this respect, the determined scores for a given supply-side user's selected opportunities may be relative to one another. For example, a supply-side user who provides feedback selecting opportunities at a high rate (e.g., velocity) may have a large number of selected opportunities. In such a case, the platform may determine that user is not discerning in their selections, and consequently, the chances of the supply side user securing any given selected opportunity may be low, thereby negatively impacting (e.g., decreasing) the scores corresponding to those opportunities. On the contrary, a supply side-user who rarely selects an opportunity may have a low number of selected opportunities indicative of a high level of discernment, thereby increasing the likelihood of the supply-side user securing any given selected opportunity which may positively (e.g., increase) the scores corresponding to those opportunities.

Further yet, the opportunity matching platform 102 may take into account various other criteria when determining a given opportunity scores such a supply-side user's performance rating, insurance level, carrier capacity, location, among various others. The opportunity matching platform 102 may determine a score for each of the given supply-side user's selected opportunities in other manners as well.

The opportunity matching platform 102 may be configured to determine the given supply-side user's opportunity scores at various times. According to one implementation, the opportunity matching platform 102 may be configured to determine a given supply-side user's opportunity scores in response to receiving a request from the given supply-side user's client station (e.g., a request for the given supply-side user's list of selected opportunities). According to another implementation the opportunity matching platform 102 may be configured to initially determine a given supply-side user's score for a given opportunity when the opportunity matching platform 102 first receives the feedback data indicating the given supply-side user's interest in the given opportunity. In such an implementation, the opportunity matching platform 102 may then be configured to update the given supply-side user's score for the given opportunity (e.g., periodically, in real-time, etc.) based on new information that may impact this score, such as new opportunities in the market, new supply-side user feedback data for the given opportunity, or new feedback data for the given supply-side user. The opportunity matching platform 102 may be configured to determine a given supply-side user's opportunity scores at other times as well. After determining a given supply-side user's opportunity scores, the opportunity matching platform 102 may be configured to store such scores as part of the given supply-side user's list of selected opportunities.

After determining a given supply-side user's opportunity scores, the opportunity matching platform 102 may be configured to perform additional functions based on the opportunity scores. For example, the opportunity matching platform 102 may be configured to rank the given supply-side user's list of selected opportunities based on the opportunity scores. As another example, the opportunity matching platform 102 may be configured to filter certain selected opportunities from the given supply-side user's list of selected opportunities based on the opportunity scores (e.g., scores reflecting opportunities with a low likelihood value and/or a low profit margin). As yet another example, the opportunity matching platform 102 may be configured to use the given supply-side user's opportunity scores as feedback indicators for future polling loops. Other examples are possible as well.

Additionally, the opportunity matching platform 102 may process the feedback data for a given supply-side user received from client station 106 to update the scores for other supply-side users in the system as well. In this respect, one supply-side user's responses may globally impact the opportunity scores (e.g., increase and/or decrease) for other supply-side users. For example, a “Yes” response provided by a given supply-side user may reflect an increased supply in the market, making it less likely that other supply-side users will be able to secure the same and/or similar opportunities and thereby causing a decrease in opportunity scores. In the same vein, a provided “No” response may indicate that other supply-side users may be more likely to secure the same and/or similar opportunities due to less supply in the market leading to an increase in their opportunity scores. Various other examples are possible. As with the given supply-side user's own opportunity scores, the opportunity matching platform 102 may be configured to update the other supply-side users' opportunity scores at various times (e.g., periodically, in real-time, in response to a request, in response to receiving new data that impacts the opportunity scores, etc.).

In yet another aspect, as shown, the opportunity matching platform 102 may process the supply-side user feedback data to potentially update the one or more opportunities that are provided to supply-side client stations at block 402.

In one implementation, for instance, the opportunity matching platform 102 may use the supply-side user feedback data to update the price options included in an open-market opportunity. As one possible example, if the supply-side user feedback data indicates a selection of the lowest price option for a given open-market opportunity (e.g., least expensive to the demand-side user and therefore the highest probability of selection), the opportunity matching platform 102 may decrease one or more of the price options for the open-market opportunity and then provide the updated open-market opportunity to the supply-side client stations in the market. As another example, if the supply-side user feedback data indicates the creation or selection of a comparable opportunity at a given price, the opportunity matching platform 102 may update the price options for the open-market opportunity in accordance with the given price for this comparable opportunity and then provide the updated open-market opportunity to the supply-side client stations in the market. Other examples are possible as well.

In practice, the opportunity matching platform 102 may be configured to update the price options for an open-market opportunity at various times throughout the opportunity's lifetime. For example, the opportunity matching platform 102 may be configured to update an open-market opportunity periodically according to a schedule (e.g., every 5 minutes). As another example, the opportunity matching platform 102 may be configured to update an open-market opportunity in response to receiving new information that may impact the open-market opportunity's price options value, such as supply-side user feedback data for the open-market opportunity, supply-side user feedback data for comparable opportunities, or a new comparable opportunity having a set price. The opportunity matching platform 102 may be configured to update the price options for an open-market opportunity at other times as well.

In another implementation, the opportunity matching platform 102 may use the supply-side user feedback data to tailor the set of one or more opportunities to be provided to supply-side users for evaluation (block 404) in the future. For example, the opportunity matching platform 102 may be configured to identify a pattern in a given supply-side user's opportunity selections and then use that pattern to tailor the set of one or more opportunities that are provided to the given supply-side user in the future (e.g., by filtering out opportunities that do not match the pattern). As another example, the opportunity matching platform 102 may be configured to use the determined opportunity scores for the given supply-side user to tailor the set or one or more opportunities that are provided to the given supply-side user in the future (e.g., by limiting future opportunities to those that are comparable to opportunities with higher scores).

At block 418, after receiving and processing the supply-side user feedback, the opportunity matching platform 102 may then provide updates to the demand-side client stations and/or and supply-side client stations that are based on the supply-side user feedback. For instance, the opportunity matching platform 102 may provide a demand-side client station with updated opportunity data that indicates than an opportunity created by the user of the demand-side client station has been matched (e.g., selected by a supply-side user) and also provides additional information about the match (e.g., information about the supply-side user, the selected price, etc.).

The opportunity matching platform 102 may also provide each of one or more supply-side client stations with updates to the list of selected opportunities for the user of the supply-side client station. These updates may take the form of modifications to the set of opportunities included on the supply-side user's list (e.g., new opportunities that have been selected at block 410), new scores for one or more opportunities on the the supply-side user's list, and/or other information about the selected opportunities on the supply-side user's list.

The act of providing the updates to the demand-side client stations and/or and supply-side client stations may take various forms. As one example, the opportunity matching platform 102 may be configured to push updates in response to various triggering events. As another example, the opportunity matching platform 102 may be configured to send an update in response to receiving a request from a client station (e.g., a request triggered by user input via the opportunity matching application). Other examples are possible as well.

At block 420, the supply-side client station 106 may receive an update from the opportunity matching platform 102, which may include a list of selected opportunities for the user of the supply-side client station 106. Thereafter, at block 422, the supply-side client station 106 may present the list of selected opportunities to the supply-side user via the client station's user interface. In a preferred embodiment, this function may be carried out by an opportunity matching application that is running on the supply-side client station 106, although other embodiments are possible as well.

In practice, the opportunity matching application may cause the supply-side client station 106 to present the list of selected opportunities to the supply-side user via the client station's user interface in response to an input from a supply-side user, such as a selection of a “Hot List” or “MFM List” view in the opportunity matching application. (It should be understood that the event that causes the supply-side client station 106 to present the list may be the same event that first causes the supply-side client station 106 to request and receive the list from the opportunity matching platform 102 at blocks 418 and 420). In addition, the opportunity matching application may cause the supply-side client station 106 to update the presentation of the list in response to various triggering events, such as the receipt of an updated list from the opportunity matching platform 102. Generally, the presented list may enable a supply-side user to monitor selected opportunities in the context of one another in order to identify the user's “best” opportunities (e.g., the opportunities where the given supply-side user has the highest chances of securing the opportunity and/or the best ability to make a profit).

Turning to 6a-b, some example GUIs are shown that may be provided by an opportunity matching application in order present a supply-side user's list of selected opportunities via the client station's user interface.

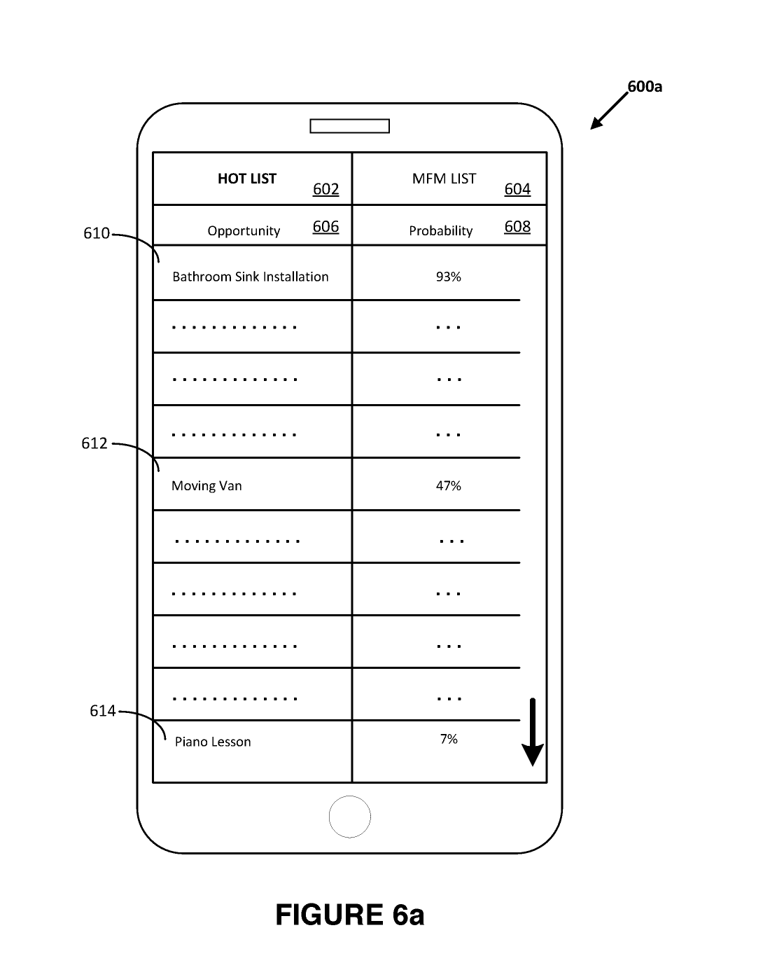

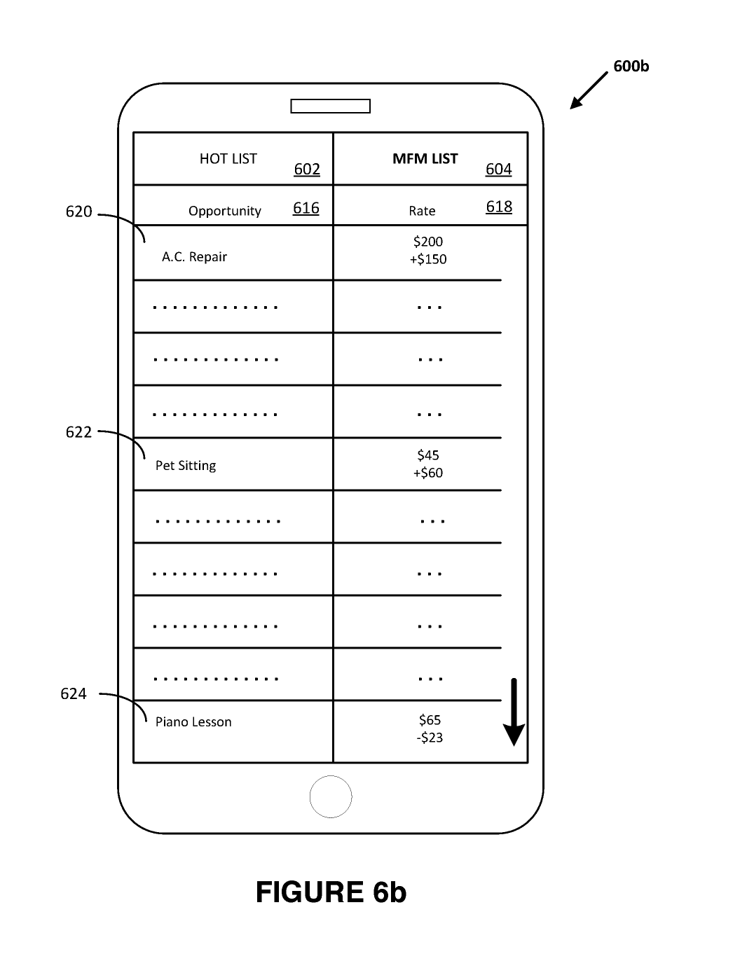

FIG. 6a shows an example GUI 600a for presenting a supply-side user's “Hot List” (i.e., available opportunities for which the user input a “YES” response or selected a given price option/probability pair). In operation, a user may use the “Hot List” tab 602 and the “MFM List” tab 604 to toggle between the different list views. As seen in FIG. 6a, “Hot List” tab 602 is indicated as selected and, correspondingly, a supply-side user's “Hot List” is displayed.

In GUI 600a, each row of the “Hot List” may contain an opportunity 606 that was previously selected by a supply-side user and a corresponding score, which may reflect the given supply-side user's chances of securing the opportunity and/or the given supply-side user's ability to make a profit on the opportunity.

Furthermore, the “Hot List” may be presented in a sorted fashion. As can be seen from interface 600a the top-most row 610 may include to an opportunity with the highest score, the middle-most row 612 may include an opportunity with an average score, and the bottom-most row 614 may include an opportunity with the lowest score. The “Hot List” may be presented as sorted in various other manners.

FIG. 6b shows an example GUI 600b for presenting an “MFM List.” As seen in FIG. 6b, the “MFM List” tab 604 is indicated as selected and, correspondingly, a supply-side user's “MFM List” is displayed.

In some implementations, each row of the “MFM List” may contain an opportunity column 616 listing opportunities previously selected by the user via an “MFM” response and a rate column 618 indicating the current price for each listed MFM opportunity and the amount the price has changed since the opportunity was initially created by a demand-side user.

Furthermore, the “MFM List” may be presented in a sorted fashion. As can be seen from interface 600b the top-most row 620 may correspond to an opportunity with the greatest amount of price change, the middle-most row 622 may correspond to an opportunity with the median amount of price change, and the bottom-most row 624 may correspond to an opportunity with least amount of price change. The “MFM List” may be presented as sorted in various other manners.

Referring again back to FIG. 4, at block 424, the opportunity matching platform 102 may receive, from a demand-side client station, an acceptance of a given opportunity that has been selected by a given supply-side user. In this respect, the demand-side user may determine which opportunity, selected by a supply-side user, to accept in a number of ways. In one instance, the demand-side user may individually examine each opportunity selected by supply-side users in order to determine a given opportunity to accept. In another instance, the demand-side user may set opportunity criteria filter(s) to facilitate determining a given opportunity to accept. Generally, the opportunity criteria filter(s) may indicate one or more business rules (e.g., supply-side user characteristics) preferred by a given demand-side user, a maximum price a demand-side user is willing pay for a given opportunity, among other criteria. The business rules, for example, may indicate a demand-side user preference for supply-side users located within a specific geographic area, having a minimum rating, having a certain insurance level, among various other examples. In example implementations, the criteria filters may be applied to the supply-side selected business opportunities received by a demand-side client station to aid the demand-side user in identifying a given opportunity to accept.

However, the demand-side user may ultimately determine who gets selected based on the business rules they applied in their criteria.

In turn, at block 426, the opportunity matching platform 102 may generate and provide updates to the demand-side and/or supply-side client stations that are based on the demand-side user's acceptance. For example, the opportunity matching platform 102 may remote the accepted opportunity from any supply-side user's list on which the opportunity previously appeared. In addition, because the accepted opportunity alters the current demand and supply in the market, the opportunity matching platform 102 may also update each supply-side user's scores for the other selected opportunities that are still available. The opportunity matching platform 102 may generate and provide other updates based on the the demand-side user's acceptance as well.

At step 428, the supply-side client station 106 may then receive an updated list of selected opportunities that has been altered to account for the demand-side user's acceptance. In turn, the supply-side client station 106 may present the updated list via the client station's user interface, thereby allowing the user of the supply-side client station 106 to review the updated list of selected opportunities.

Although not shown, the opportunity matching platform 102, the demand-side client stations, and the supply-side client stations may perform various other functions as well. For example, once an opportunity has been accepted, the opportunity matching platform 102, the demand-side client station 108, and the supply-side client station 106 may perform addition functions to facilitate the transaction between the demand-side and supply-side users. Other functions are possible as well.

While the above discussion associates the functions with particular entities in the network configuration (e.g., the opportunity matching platform 102 or the supply-side client station 106), it should also again be understood that this association is merely for purposes of illustration, and that one or more of the functions discussed above may be carried out in part or in whole by another entity in the network configuration.

For example, instead of processing the feedback data for a given supply-side user entirely at the opportunity matching platform 102, at least some of the processing functions described above may be performed in part or in whole by the supply-side client station 106 associated with the given supply-side user, including generating and/or updating the list of selected opportunities for the given supply-side user, determining and/or updating the opportunity scores for the given supply-side user, and/or modifying the list of selected opportunities for the given supply-side user based on the opportunity scores. In this respect, the supply-side client station 106 may additionally be configured to provide the results of its processing functions to the opportunity match platform 102 (e.g., a generated/updated list of selected opportunities or new opportunity scores), rather than receiving that information from the opportunity match platform 102.

As another example, instead of tailoring the set of one or more opportunities to be presented to a given supply-side user (e.g., based on a user profile, user feedback data, etc.) at the opportunity matching platform 102, such tailoring may be carried out in part or in whole at the supply-side client station 106 associated with the given supply-side user.

As yet another example, it is possible that certain opportunity data, feedback data, and/or acceptance data may be communicated between the demand-side client stations and supply-side client stations without involving the opportunity matching platform 102. Other examples are possible as well.

### V. CONCLUSION

Example embodiments of the disclosed innovations have been described above. Those skilled in the art will understand, however, that changes and modifications may be made to the embodiments described without departing from the true scope and sprit of the present invention, which will be defined by the claims.

Further, to the extent that examples described herein involve operations performed or initiated by actors, such as “humans,” “operators,” “users” or other entities, this is for purposes of example and explanation only. The claims should not be construed as requiring action by such actors unless explicitly recited in the claim language.

1. A computing system comprising:
a network interface configured to facilitate communication, via a communication network, with a plurality of demand-side client stations that are each associated with a respective demand-side user and a plurality of supply-side client stations that are each associated with a respective supply-side user;
at least one processor;
a non-transitory computer-readable medium; and
program instructions stored on the non-transitory computer readable medium that are executable by the at least one processor to cause the computing system to:
receive, via the network interface, data indicative of one or more business opportunities created by one or more demand-side users;
provide, via the network interface, the one or more business opportunities to each of the plurality of supply-side client stations;
for each of the plurality of supply-side client stations:
receive, from the supply-side client station via the network interface, feedback data for the respective supply-side user associated with the supply-side client station, wherein the feedback data indicates a response by the respective supply-side user to each of at least a subset of the one or more business opportunities;
based on the received feedback data for the respective supply-side user, (a) generate a list of selected business opportunities for the respective supply-side user and (b) for each of a least a subset of business opportunities in the list of selected business opportunities for the respective supply-side user, determine a score that reflects one or both of (i) a likelihood of the respective supply-side user securing the business opportunity and (ii) an estimated ability of the respective supply-side user to make a profit on the business opportunity; and
provide, to the supply-side client station via the network interface, the list of selected business opportunities and the determined score for each of the subset of business opportunities in the list of selected business opportunities for the respective supply-side user.

2. The computing system of claim 1, wherein the one or more business opportunities comprise one or both of (i) a contract opportunity having a price set by a demand-side user and (ii) an open-market opportunity without a set price.

3. The computing system of claim 2, wherein program instructions stored on the non-transitory computer-readable medium that are executable by the at least one processor further cause the computing system to:
define a set of price options for an open-market opportunity, wherein each price option corresponds to a respective probability of securing the open-market opportunity.

4. The computing system of claim 3, wherein program instructions stored on the non-transitory computer-readable medium that are executable by the at least one processor further cause the computing system to:
based on the received feedback data for at least one supply-side user, dynamically update the set of price options for the open-market opportunity.

5. The computing system of claim 1, wherein program instructions stored on the non-transitory computer-readable medium that are executable by the at least one processor further cause the computing system to:
receive, via the network interface, data indicative of additional business opportunities created by one or more demand-side users; and
for each of the plurality of supply-side client stations:
based on the received feedback data for the respective supply-side user, select a subset of the additional business opportunities to be provided to the supply-side client station; and
provide, via the network interface, the selected subset of additional business opportunities to the supply-side client station.

6. The computing system of claim 1, wherein the program instructions that are executable by the at least one processor to cause the computing system to determine a score of a given business opportunity for a respective supply-side user comprises program instructions that are executable by the at least one processor to cause the computing system to determine the score of the business opportunity based on a current demand, a current supply, the one or more other business opportunities in the list of selected business opportunities for the respective supply-side user, and a cost for the respective supply-side user to service the given business opportunity.

7. The computing system of claim 1, wherein program instructions stored on the non-transitory computer-readable medium that are executable by the at least one processor further cause the computing system to:
provide, to one or more demand-side client stations, updates to the one or more business opportunities that are based on the received feedback data for at least one supply-side user.

8. The computing system of claim 7, wherein program instructions stored on the non-transitory computer-readable medium that are executable by the at least one processor further cause the computing system to:
receive, from a given demand-side client station via the network interface, acceptance data indicating that a given opportunity has been accepted by a given demand-side user;
for any supply-side user having a list of selected business opportunities that includes the given opportunity, update the list selected business opportunities for the supply-side user to remove the given opportunity from the list; and
for each of the respective supply-side users, update the determined scores for the subset of business opportunities in the list of selected business opportunities.

9. The computing system of claim 1, wherein the list of selected business opportunities for a respective supply-side user comprises a first list of opportunities associated with a first type of response by the respective supply-side user and a second list of opportunities associated with a second type of response by the respective supply-side user.

10. A computer-implemented method comprising:
receiving, via a communication network, data indicative of one or more business opportunities created by one or more demand-side users;
providing, via the communication network, the one or more business opportunities to a plurality of supply-side client stations that are each associated with a respective supply-side user;
for each of the plurality of supply-side client stations:
receiving, from the supply-side client station via the communication network, feedback data for the respective supply-side user associated with the supply-side client station, wherein the feedback data indicates a response by the respective supply-side user to each of at least a subset of the one or more business opportunities;
based on the received feedback data for the respective supply-side user, (a) generating a list of selected business opportunities for the respective supply-side user, and (b) for each of a least a subset of business opportunities in the list of selected business opportunities for the respective supply-side user, determining a score that reflects one or both of (i) a likelihood of the respective supply-side user securing the business opportunity and (ii) an estimated ability of the respective supply-side user to make a profit on the business opportunity; and
providing, to the supply-side client station via the communication network, the list of selected business opportunities and the determined score for each of the subset of business opportunities in the list of selected business opportunities for the respective supply-side user.

11. A computer-implemented method carried out by a client station that is associated with a given supply-side user, the method comprising:
receiving, from an opportunity matching platform via a communication network, one or more business opportunities created by one or more demand-side users;
presenting, via a user interface of the client station, each of the one or more business opportunities successively for evaluation by the given supply-side user;
while presenting each of the the one or more business opportunities, receiving, via the user interface, a response by the given supply-side user to the business opportunity;
transmitting, via the communication network, feedback data for the given supply-side user, wherein the feedback data indicates a response by the given supply-side user to each of at least a subset of the one or more business opportunities;
receiving, from the opportunity matching platform via the communication network, (a) a list of selected business opportunities for the given supply-side user, and (b) for each of at least a subset of business opportunities in the list of selected business opportunities, a score that reflects one or both of (i) a likelihood of the given supply-side user securing the business opportunity and (ii) an estimated ability of the given supply-side user to make a profit on the business opportunity; and
presenting, via the user interface, the list of selected business opportunities for the given supply-side user and the score for each of the subset of business opportunities in the list of selected business opportunities for the given supply-side user.

12. The computer-implemented method of claim 11, wherein presenting each of the one or more business opportunities successively for evaluation by the given supply-side user comprises
presenting a given opportunity with a set of options for responding to the given opportunity, wherein each option can be selected via one or both of a respective swipe gesture and a respective button.

13. The computer-implemented method of claim 12, wherein the given opportunity comprises a contract opportunity having a price set by a demand-side user, and wherein the set of options for responding to the given opportunity comprises:
a “Yes” response that can be selected via one or both of a rightward swipe gesture and a “Yes” button;
a “Maybe for More” response that can be selected via one or both of a downward swipe gesture and a “Maybe or More” button; and
a “No” response that can be selected via one or both of a leftward swipe gesture and a “No” button.

14. The computer-implemented method of claim 13, wherein the list of selected business opportunities for the given supply-side user comprises a first list of one or more contract opportunities for which a “Yes” response was received and a second list of one or more contract opportunities for which a “Maybe for More” response was received.

15. The computer-implemented method of claim 14, wherein the opportunities in the first list are presented with corresponding scores, and wherein the opportunities in the first list are sorted based on the corresponding scores.

16. The computer-implemented method of claim 14, the opportunities in the second list are each presented with (i) a current price of the opportunity and (ii) a differential value between the current price and the initial price of the opportunity, and wherein the opportunities in the second list are sorted based on the differential values.

17. The computer-implemented method of claim 11, wherein the given opportunity comprises an open-market opportunity having a set of price options that each correspond to a respective probability of securing the open-market opportunity, and wherein the set of options for responding to the given opportunity comprises:
a low price bid that can be selected via one or both of a rightward swipe gesture and a low price bid button;
a medium price bid that can be selected via one or both of a downward swipe gesture and and a medium price bid button; and
a high price bid that can be selected via one or both of a leftward swipe gesture and a high price bid button.

18. The computer-implemented method of claim 17, wherein the list of selected business opportunities for the given supply-side user comprises a list of one or more open-market opportunities for which a bid was was received.

19. The computer-implemented method of claim 10, further comprising:
receiving, from the opportunity matching platform via the communication network, an update to one or both of (a) the list of selected business opportunities for the given supply-side user, and (b) a score for at least one business opportunity in the list of selected business opportunities; and
presenting, via the user interface, the update to one or both of the list of selected business opportunities for the given supply-side user and the score for the at least one business opportunity in the list of selected business opportunities.

20. A client station that is associated with a given supply-side user, the client station comprising:
a network interface configured to facilitate communication, via a communication network, with an opportunity matching platform that facilitates interaction between demand-side users and supply-side users;
a user interface;
at least one processor;
a non-transitory computer-readable medium; and
program instructions stored on the non-transitory computer readable medium that are executable by the at least one processor to cause the client station to:
receive, from the opportunity matching platform via the network interface, one or more business opportunities created by one or more demand-side users;
present, via the user interface, each of the one or more business opportunities successively for evaluation by the given supply-side user;
while presenting each of the the one or more business opportunities, receive, via the user interface, a response by the given supply-side user to the business opportunity;
transmit, via the network interface, feedback data for the given supply-side user, wherein the feedback data indicates a response by the given supply-side user to each of at least a subset of the one or more business opportunities;
receive, from the opportunity matching platform via the network interface, (a) a list of selected business opportunities for the given supply-side user, and (b) for each of at least a subset of business opportunities in the list of selected business opportunities, a score that reflects one or both of (i) a likelihood of the given supply-side user securing the business opportunity and (ii) an estimated ability of the given supply-side user to make a profit on the business opportunity; and
present, via the user interface, the list of selected business opportunities for the supply-side user and the score for each of the subset of business opportunities in the list of selected business opportunities for the given supply-side user.
